(19) United States
(12) Patent Application Publication
(10) Pub. No.: US 2008/0167777 A1
(43) Pub. Date: Jul. 10, 2008

(54) Method for Controlling the Steering Orientation of a Vehicle

(75) Inventor: Richard Pothin, Jouars Pontchartrain (FR)

Correspondence Address: OBLON, SPIVAK, MCCLELLAND MAIER & NEUSTADT, P.C., 1940 DUKE STREET, ALEXANDRIA, VA, 22314, US

(73) Assignee: RENAULT S.A.S., Boulogne-Billancourt (FR)

(21) Appl. No.: 11/996,459

(22) PCT Filed: Jun. 14, 2006
(86) PCT No.: PCT/FR2006/050559

§ 371 Date: Mar. 25, 2008

(30) Foreign Application Priority Data
Jul. 25, 2005 (FR) 0507891

(51) Int. Cl. G06F 19/00

(52) U.S. Cl. 701/41

(57) ABSTRACT

A method for controlling steering orientation of a monitored vehicle including at least two steering wheels each of which is steerable independently of the other at an angle of natural orientation, the wheels belonging to a train of the vehicle. The method collects a lateral acceleration setpoint, and computes orientation setpoints of each steering wheel based on the lateral acceleration setpoint. During the operation for computing the orientation setpoints of the steering wheels, the orientation setpoints of each of the wheels of the train are computed such that the difference between the grip levels of the wheels relative to the ground is less than a threshold value.

The present invention relates, generally, to the field of the orientation of steerable wheels of one and the same steering axle assembly of a vehicle whose wheels are orientable independently of one another.

More particularly, the invention relates to a method of controlling the steering orientation of a driven vehicle comprising at least two steerable wheels each of which is orientable independently of the other according to an inherent angle of orientation, these wheels belonging to an axle assembly of the vehicle, this method comprising a step of collecting a lateral acceleration setpoint, and a step of calculating orientation setpoints for each steerable wheel as a function of said lateral acceleration setpoint.

In order to improve the behavior of a vehicle equipped with a steering axle assembly possessing at least two wheels each orientable independently of the other, and consequently in order to increase the safety of the passengers of the vehicle, vehicle manufacturers have developed strategies for orienting these wheels.

A control method of the type defined above, allowing such orientation of the steerable wheels of this vehicle, is for example described in the patent document EP1147960.

This document describes the use of a measurement of the lateral loadings exerted by the ground on each wheel of the vehicle so as to control the trajectory of the vehicle. For this purpose it is proposed to act on the front and rear suspensions of the vehicle as a function of the measurements.

In this context, the aim of the present invention is to propose a method of controlling the steering orientation allowing an alternative solution for the dynamic distribution of the loadings on the wheels of the vehicle as a function of the setpoint given by the driver of the vehicle.

To this end, the method of the invention, additionally in accordance with the generic definition given thereof by the preamble defined previously, is essentially characterized in that during the operation of calculating the orientation setpoints of the steerable wheels, orientation setpoints are calculated for each of the wheels of said axle assembly so that the difference between the levels of grip μ of these wheels with respect to the ground is less than a limit value.

The invention allows better distribution of the loadings on the wheels of one and the same axle assembly and therefore better utilization of the grip potential of each of the wheels of this axle assembly.

Specifically, the invention is aimed at equalizing the levels of grip of the wheels of one and the same axle assembly, by controlling the angle of orientation of each of these wheels. Perfect equalization of the levels of grip of the wheels of one and the same axle assembly is in fact particularly difficult to obtain, and this is the reason why a limit value is introduced which corresponds to a limit tolerance value of difference in grip between these wheels. The equalization of the levels of grip is therefore true to within a limit value that one seeks to minimize as far as possible. The difficulty in obtaining equal levels of grips between the wheels of one and the same axle assembly is related for example to imperfections of the calculation models, to the response time of the system controlling the angles of orientation of the wheels, to the imperfections of the carriageway.

In short, the invention consists in translating the lateral acceleration setpoint requested by the driver into angle setpoints for steerable wheels such that a first equivalent level of grip is obtained on the two tires of the front axle assembly. By virtue of this search for an equivalence of the levels of grip of the wheels of one and the same axle assembly, the invention makes it possible to improve the stability and the handleability of the vehicle while complying with the trajectory setpoint given by the driver.

It is possible for example to contrive matters so that the method is implemented on a vehicle comprising four steerable wheels each of which is orientable independently of the other according to an inherent angle of orientation, two of these wheels belonging to a front axle assembly of the vehicle and two others of these wheels belonging to a rear axle assembly of the vehicle, the method being furthermore characterized in that during the operation of calculating the orientation setpoints of the steerable wheels:
orientation setpoints are calculated for each of the wheels of the front axle assembly so that the difference between the levels of grip of these wheels with respect to the ground is less than said first limit value and;
orientation setpoints are calculated for each of the wheels of the rear axle assembly so that the difference between the levels of grip of these wheels with respect to the ground is less than a second limit value.

By virtue of this embodiment the wheels of one and the same axle assembly have a level of grip that is substantially mutually equivalent to within limit values (first and second values) that one seeks to minimize. The levels of grips of each axle assembly, front and rear, are adjusted as a function of the requirements specific to each axle assembly of the vehicle, for this purpose, the levels of grips of the front and rear axle assemblies are not necessarily mutually equivalent.

The handleability of the vehicle as a whole is thus increased since each axle assembly possesses its own inherent equivalent level of grip.

It is also possible to contrive matters so that the level of grip μ of a wheel is calculated by applying the formula μ=F_{y}/F_{z} with F_{y} representing the transverse force applied to this wheel by the ground and with F_{z} representing the vertical force applied to this wheel by the ground.

According to a particular embodiment, the vertical loadings of each wheel can be measured by load sensors.

It is also possible to contrive matters so that the vertical force applied to the wheel is estimated at least on the basis of the longitudinal and transverse acceleration of the vehicle, by taking into account the static load of the vehicle and longitudinal and transverse dynamic load transfers.

It is also possible to contrive matters so that one at least of the longitudinal and transverse accelerations of the vehicle is constituted by or derived from a measurement signal delivered by at least one sensor.

A longitudinal and transverse acceleration signal can originate from one or more accelerometers placed on the vehicle or can for example originate from a splitting of a signal originating from one or more speed sensors positioned on the vehicle.

It is also possible to contrive matters so that the longitudinal acceleration of the vehicle is obtained on the basis of at least one measurement of instantaneous speed of the vehicle.

It is also possible to contrive matters so that the transverse acceleration of the vehicle is estimated on the basis of a measurement of the instantaneous speed of the vehicle and of a measurement of an angle of rotation of the steering wheel of this vehicle. The use of the measurement of instantaneous speed with the angle of rotation of the steering wheel makes it possible to correlate a measured speed with a cue regarding the trajectory desired by the driver, thereby making it possible to approach the real speed of the vehicle over time and thereby making it possible to deduce therefrom the transverse and longitudinal accelerations.

It is also possible to contrive to calculate the level of grip μ₁ of a first wheel of the front axle assembly of the vehicle using the function

$${μ}_{1} = {F}_{y 11} / {F}_{z 11} = \frac{{M}_{front} ( γ t + {L}_{1} \ddot{ψ} )}{{F}_{z 11} + {F}_{z 12}}$$

where F_{z11} represents the vertical force applied to this first wheel of the front axle assembly (R₁₁) by the ground and F_{z12} represents the vertical force applied to the second wheel of this front axle assembly (R₁₂) by the ground, M_{front} represents the total vehicle mass distributed over this front axle assembly, γt represents the vehicle's lateral acceleration measured or evaluated at the center of gravity (G) of this vehicle, L₁ represents the distance between the front axle assembly of the vehicle and the center of gravity (G) and ψ represents the acceleration of the yaw motion of the vehicle.

It is also possible to contrive to calculate the level of grip μ₂ of a first wheel of the rear axle assembly of the vehicle using the function

$${μ}_{2} = {F}_{y 21} / {F}_{z 21} = \frac{{M}_{rear} ( γ t + {L}_{2} \ddot{ψ} )}{{F}_{z 21} + {F}_{z 22}}$$

where F_{z21} represents the vertical force applied to this first wheel of the rear axle assembly (R₁₁) by the ground and F_{z12} represents the vertical force applied to the second wheel of this rear axle assembly (R₂₂) by the ground, Mᵣₑₐᵣ represents the total vehicle mass distributed over this rear axle assembly, γt represents the vehicle's lateral acceleration measured or evaluated at the center of gravity (G) of this vehicle, L₂ represents the distance between the rear axle assembly of the vehicle and the center of gravity (G) and ψ represents the acceleration of the yaw motion of the vehicle.

The acceleration of the yaw motion ψ, corresponds to the second derivative over time of the rotational motion of the vehicle with respect to a vertical axis passing through the center of gravity G of this vehicle.

It is also possible to contrive to calculate each steerable wheel orientation setpoint by inverting a reference calculation model, said model comprising an operation consisting in calculating the transverse force applied to the wheel as a function of the orientation of this wheel and of parameters of dynamic behavior of the vehicle. A detailed example of this model is given in the following detailed description.

Other characteristics and advantages of the invention will clearly emerge from the description thereof given hereinafter, by way of wholly nonlimiting indication, with reference to the appended drawings, in which:

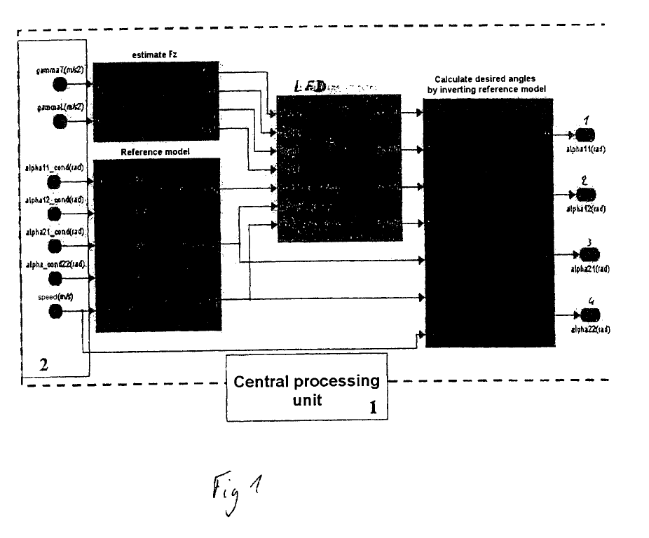

FIG. 1 represents a basic diagram of the invention with obtaining of the angles of deflection of each steerable wheel by inverting a reference model;

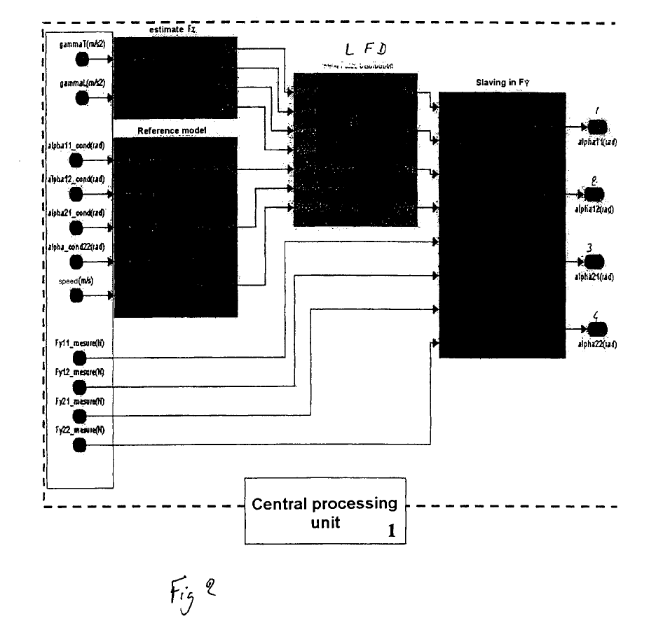

FIG. 2 represents a basic diagram of the invention with obtaining of the angles of deflection of each steerable wheel by a slaving in terms of lateral loading;

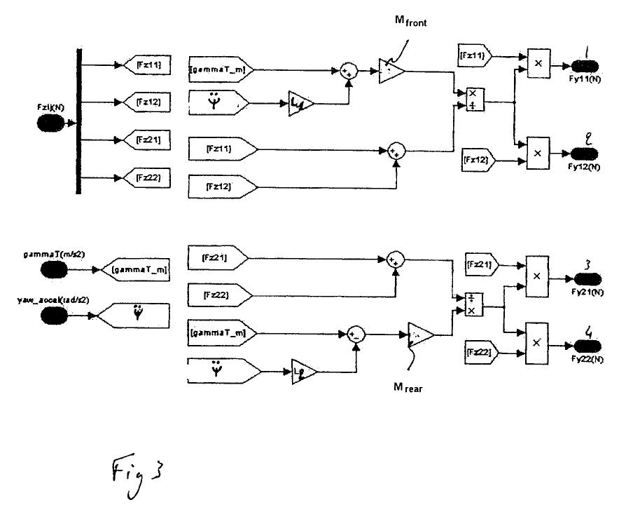

FIG. 3 represents a basic diagram of a sub-block numbered 5 in FIGS. 1 and 2, this sub-block (called block LFD) making it possible to calculate the lateral transverse loadings exerted on each steerable wheel.

As declared previously, the invention relates to a method of controlling the steering orientation of a driven motor vehicle. This method makes it possible to optimize the lateral potentials of a vehicle equipped with a system for controlling the four wheel angles without modifying its trajectory.

This makes it possible for example to improve the stability of the vehicle in the phases where it experiences strong transverse accelerations and weak longitudinal accelerations.

The invention relates to a control strategy which distributes the four lateral loadings over the steerable wheels so as to improve the behavior of the vehicle and consequently the safety of the driver.

It is particularly adapted for systems which make it possible to have the four angles of deflection also called directional angles of wheels that are orientable independently of one another (such systems are known in the technical field by the expression “steer by wire”).

The invention is implemented on a vehicle comprising at least one device for driving the four steerable wheel angles, one or more sensors allowing the measurement of the vehicle speed and the estimation or the measurement of the longitudinal acceleration, of the angle at the steering wheel, the estimation or the measurement of the transverse acceleration and of one or more electronic calculation means.

The invention consists in translating the lateral acceleration setpoint requested by the driver into four angle setpoints to be given to the steerable wheels, these setpoints being distributed in such a way as to always obtain a first equivalent level of grip on the two tires of the front axle assembly and a second level of grip on the two tires of the rear axle assembly.

The strategy evens out the lateral potentials per axle assembly so as to comply with the lateral acceleration setpoint requested by the driver.

It takes account of the estimated vertical load at the wheel. Consequently on a bend, the lateral load transfer leads to an increase in the angle of deflection on the outside and a decrease on the inside.

The stability is thus improved in critical phases such as for example the phase where the vehicle experiences a strong transverse acceleration and a weak longitudinal deceleration. The invention makes it possible to attenuate roll engagement of the vehicle and improves comfort on bends while complying with the transverse acceleration setpoint (also called the lateral acceleration setpoint) requested by the driver.

### NOTATION AND ABBREVIATIONS

M (kg): Total mass of the vehicle
M_{front} (kg): Total mass of the front axle assembly
Mᵣₑₐᵣ (kg): Total mass of the rear axle assembly
Iz (N.m): Inertia of the vehicle about a vertical axis passing through its center of gravity G
h(m): Height of the vehicle at the center of gravity G
L₁ (m): Distance from G to the front axle
L₂ (m): Distance from G to the rear axle
e₁: front track
e₂: rear track
L(m): Wheelbase of the vehicle (distance between the front and rear axle assemblies)
D₁ (N/rad) Drift rigidity of the front axle assembly
D₂ (N/rad): Drift rigidity of the rear axle assembly
Dij (N/rad): Drift rigidity of the wheels ij
H₁ (N/rad): Front camber rigidity
H₂ (N/rad): Rear camber rigidity
Bal (m): Front swing radius
Dem (s.u.): Scaledown from steering wheel deflection angle to wheel deflection angle
α_{(1,2)} (rad): Mean deflection angle of the (front/rear) axle assembly
α_{ij cond} (rad): Angles of deflection of the wheels ij as requested by the driver (also denoted alpha i, j)
αᵢⱼ (rad): Angles of deflection of the wheels ij requested by the strategy
V (m/s): Speed of the vehicle
ψ (rad/s): Yaw rate (also denoted yaw_rate_m), rate of rotation of the vehicle about its center of gravity along a vertical axis.
ψ (rad/s²): Yaw acceleration (also denoted yaw_accel_m), rotational acceleration of the vehicle about its center of gravity along a vertical axis.
γₜ (m/s²): Lateral acceleration (also denoted gammaT_m), it is measured at the center of gravity G (also denoted gammaT).
γ_{L} (m/s²): Longitudinal acceleration, it is measured at the center of gravity G (also denoted gammaL).
δ (rad): Angle of drift, the angle that the velocity vector of the vehicle makes with its longitudinal axis.
δij (rad): Angle of drift of the wheels ij.
F_{Yij}: lateral force or force transverse to the wheel: projection of the reaction of the ground on the wheel along the transverse axis of the wheel
F_{Zij}: force vertical to the wheel: projection of the reaction of the ground on the wheel along the vertical axis of the wheel
μ=Fy/F_{z}: lateral potential
i,j: index of the wheels, the first index signifies front/rear, the second left/right.

For example 1,1 signifies front left wheel, 2,1 signifies rear left wheel, 2,2 signifies rear right wheel and 1,2 signifies front right wheel.

The control method is a structure which can be broken down into five parts:
Input signals (block No. 2—FIG. 1).
Estimation of the vertical loadings Fz (block No. 3—FIG. 1).
Reference model (block No. 4—FIG. 1).

Distributing of the lateral loadings F calculated LFD (block No. 5—FIG. 1).
Calculation of the desired angles αᵢⱼ by inverting the reference model (block No. 6—FIG. 1).

### DESCRIPTION OF EACH COMPONENT

### 1—The Input Signals (BLOCK No. 2—FIG. 1)

In order to implement the method of the invention, the following measurements or signals are needed:
Speed of the vehicle: This signal is, for example, obtained by taking the mean of the speed ABS of the wheels of an axle/axle assembly.

Deflection angle αᵢⱼ of the four wheels: This signal can, for example, be obtained by a sensor.

Longitudinal acceleration γ_{L} of the vehicle: This signal can, for example, be obtained by a sensor or by estimation.
Transverse acceleration γₜ of the vehicle: This signal can, for example, be obtained by a sensor or by estimation.

Example of Estimating the Lateral and Longitudinal Accelerations:

The longitudinal acceleration is estimated by an observer (system furnished with sensors) on the basis of the speed of the vehicle and the driver braking request according to the following principle:

The driver request gives a first estimation γ_{L} Of the acceleration. We introduce d which models the error of models the modeling error (mass etc.):

{circumflex over (\dot{v}=γ_{L}+d+k₁(v−\hat{v})

\dot{d}=k₂(v−\hat{v})

And \hat{γ}_{L}=γ_{L}+d.

With (v) which represents the measured speed of the vehicle, (v) which represents the estimated speed of the vehicle and k₁ k₂ which represent respectively the convergence gains of the observer for the respective front and rear axle assemblies.

The first estimation is obtained by dividing the driver braking setpoint denoted “Brake_Force_Request” by the maximum mass of the vehicle denoted Mass_Max. Specifically, it is preferable to underestimate the signal, so as to underestimate the load transfer.

$${γ}_{L} = - \frac{Brake\_Force \_Request}{Mass\_Max}$$

The swiftness of derivation/sensitivity to noise compromise is adjusted by acting on the parameters k₁ and k₂.

Alternatively or as a supplement to the mode for calculating the lateral acceleration of the vehicle presented above, this acceleration can, also, be obtained by a sensor or by estimation with the aid of a model.

The transverse acceleration is for example estimated by a two-wheel model of the vehicle (cf. Equation 1 hereinafter).

For this purpose the model uses the measured angle of deflection mean_α of the wheels of the axle assembly considered and the speed V of the vehicle according to the following equations:

$$\frac{\partial }{\partial t} [ \begin{matrix}\dot{ψ} \\ δ\end{matrix} ] = ( \begin{matrix}- \frac{{D}_{1} {L}_{1}^{2} + {D}_{2} {L}_{2}^{2}}{{VI}_{\approx }} & \frac{{D}_{2} {L}_{2} - {D}_{1} {L}_{1}}{{I}_{\approx }} \\ - 1 + \frac{{D}_{2} {L}_{2} - {D}_{1} {L}_{1}}{{MV}^{2}} & - \frac{{D}_{1} + {D}_{2}}{MV}\end{matrix} ) [ \begin{matrix}\dot{ψ} \\ δ\end{matrix} ] + ( \begin{matrix}\frac{{D}_{1} {L}_{1}}{{I}_{\approx }} \\ \frac{{D}_{1}}{MV}\end{matrix} ) α$$

$${γ}_{t} = ( \frac{{D}_{2} {L}_{2} - {D}_{1} {L}_{1}}{MV} - \frac{{D}_{1} + {D}_{2}}{M} ) [ \begin{matrix}\dot{ψ} \\ β\end{matrix} ] + \frac{{D}_{1}}{M} α$$

### Equation 1

### Two-Wheel Model

In a particular embodiment of the invention it is possible to include a verification function to check the consistency of the sensors.

Specifically, if the measurements of the mean angle of deflection of the front wheels, of the vehicle speed V and of the longitudinal and transverse accelerations are available, it is then possible to verify the consistency of the sensors by comparing the signals of the accelerometers with the accelerations estimated by the two-wheel model and by the observer.

In the event that an inconsistency is detected, a degraded mode of distribution is implemented. The degraded mode can consist for example in totally halting the loading distribution strategy or in sending an inconsistency signal to a central processing unit.

### 2—Estimation of the Vertical Loadings Fz (Block No. 3—FIG. 1)

The longitudinal γ_{L} and transverse accelerations obtained in the previously detailed block 2 are transmitted to block 3 whose function is to calculate the vertical loadings F_{Zij} of each wheel.

These vertical loadings are estimated by taking account of the longitudinal and lateral dynamic load transfers and of the static load through the following equations:

$${F}_{Z 11} = - \frac{{K}_{1}}{{e}_{1}} hM {γ}_{ι} - \frac{hM {γ}_{L}}{2 L} + \frac{{L}_{2} Mg}{2 L}$$

$${F}_{Z 12} = + \frac{{K}_{1}}{{e}_{1}} hM {γ}_{ι} - \frac{hM {γ}_{L}}{2 L} + \frac{{L}_{2} Mg}{2 L}$$

$${F}_{Z 21} = - \frac{{K}_{2}}{{e}_{2}} hM {γ}_{ι} + \frac{hM {γ}_{L}}{2 L} + \frac{{L}_{1} Mg}{2 L}$$

$${F}_{Z 22} = + \frac{{K}_{2}}{{e}_{2}} hM {γ}_{ι} + \frac{hM {γ}_{L}}{2 L} + \frac{{L}_{1} Mg}{2 L}$$

### Equation 2

### Procedure for Estimating the Vertical Loadings

where K₁ and K₂ are coefficients related to the suspensions of the vehicle.

### 3—Reference Model (Block No. 4—FIG. 1)

In parallel with block No. 3, the function of block No. 4 is to calculate the yaw acceleration ψ of the vehicle, as well as the transverse acceleration gammaT or γₜ and the yaw rate \dot{ψ} the vehicle by using data obtained in block No. 2, that is to say the speed of the vehicle and the measured angles of deflection of the steerable wheels.

These calculations are carried out by using a reference model which can for example be defined by the following equations:

Mγ₁=F_{γ11}+F_{γ12}+F_{γ21}+F_{γ22} EQUATION-A

I_{Z}\ddot{ψ}=L₁(F_{γ11}+F_{γ12})−L₂(F_{γ21}+F_{γ22}) EQUATION-B

V(α₁₁+δ₁₁)=(Vδ+\dot{ψ}L₁)/2 EQUATION-C

V(α₁₂+δ₁₂)=(Vδ+\dot{ψ}L₁)/2 EQUATION-D

V(α₂₁₁+δ₂₁)=(Vδ−\dot{ψ}L₂)/2 EQUATION-E

V(α₂₂+δ₂₂)=(Vδ−\dot{ψ}L₂)/2 EQUATION-F

γ₁=V(\dot{ψ}=\dot{δ}) EQUATION-G

$${F}_{γ 11} = \frac{- {D}_{11} {δ}_{11}}{1 + \frac{Bal}{V} s} , {F}_{γ 12} = \frac{- {D}_{12} {δ}_{12}}{1 + \frac{Bal}{V} s} , {F}_{γ 21} = \frac{- {D}_{21} {δ}_{21}}{1 + \frac{Bal}{V} s} = \frac{- {D}_{22} {δ}_{22}}{1 + \frac{Bal}{V} s} \qquad EQUATION \text{-} H$$

### Equation 3

### Reference Model Example

In this model “s” denotes the Laplace transform which makes it possible to take the temporally transient phenomena into account.

### 4—LFD (Block No. 5—FIG. 1)

Block No. 5 uses the data calculated by blocks No. 3 and 4, that is to say the vertical loadings Fz at each wheel, the yaw acceleration, the transverse acceleration gammaT and the yaw rate to determine the loadings that have to be applied to each steerable wheel.

The distribution of the lateral loadings must satisfy the following objectives:
For each wheel ij of a given axle assembly, the lateral potential, defined by the ratio of the lateral loading to the vertical loading, is equal to μ (front or rear)
The lateral acceleration requested by the driver must be complied with.

Consequently, the distribution must therefore satisfy the following equations:

F_{γ11}=μ_{front}F_{z11}

F_{γ12}=μ_{front}F_{z12}

F_{γ21}=μᵣₑₐᵣF_{z21}

F_{γ22}=μᵣₑₐᵣF_{z22}

Mγ₁=ΣF_{yij}

γₜᵣₑₐᵣ=γₜ−L₂\ddot{ψ}

γ_{tfront}=γₜ−L₁\ddot{ψ}

### Equation 4

### Equations of the Distribution

Solving these equations gives the distribution of lateral loadings:

$${F}_{γ 11} = \frac{{M}_{front} ( γ t + {L}_{1} \ddot{ψ} )}{{F}_{z 11} + {F}_{z 12}} {F}_{z 11}$$

$${F}_{γ 12} = \frac{{M}_{front} ( γ t + {L}_{1} \ddot{ ψ} )}{{F}_{z 11} + {F}_{z 12}} {F}_{z 12}$$

$${F}_{γ 21} = \frac{{M}_{rear} ( γ t + {L}_{2} \ddot{ψ} )}{{F}_{z 21} + {F}_{z 22}} {F}_{z 21}$$

$${F}_{γ 22} = \frac{{M}_{rear} ( γ t + {L}_{2} \ddot{ψ} )}{{F}_{z 21} + {F}_{z 22}} {F}_{z 22}$$

### Equation 5

### Distribution of the Lateral Loadings Solving the Problem

In order to manage the variations in grip, it is noted that saturation levels on the loadings have to be added. The latter saturation levels may depend on the diverse measured variables of the vehicle such as for example the longitudinal acceleration and the transverse acceleration.

A basic diagram of this block 5 is detailed in FIG. 3 in which:
the inputs of block 5 are the four loadings F_{Zij} obtained from block 3, the transverse acceleration gammaT_m, the yaw rate yaw_rate_m obtained from block 4;
the outputs of block 5 are the transverse loadings of the ground on each wheel.

Block 5 is composed of a sub-block for calculating the transverse loadings applied to the wheels of the front axle assembly and of a sub-block for calculating the transverse loadings on the wheels of the rear axle assembly.

The sub-block of the front axle assembly comprises an operation of multiplying the yaw acceleration by the distance L1 thereby giving a first result which is added to the transverse acceleration (gammaT_m), thereby giving a second result. The second result thus obtained is then multiplied by the mass distributed over the front axle assembly, thereby giving a third result. In parallel, the vertical loadings of the front wheels of this axle assembly are added, thereby giving a fourth result. The third result is then divided by the fourth result thereby giving a fifth result.

This fifth result is then multiplied by the vertical loading applied to a wheel of the front axle assembly to ascertain the transverse loading which is applied to this wheel.

The sub-block for calculating the transverse loadings applied to the rear axle assembly is identical to the sub-block for calculating the loadings applied to the rear axle assembly except for the difference that the distance L1 is replaced with the distance L2, the vehicle mass distributed over the front axle assembly is replaced with the vehicle mass distributed over the rear axle assembly and the vertical loadings applied to the wheels are those applied to the wheels of the rear axle assembly.

The data thus obtained in block 5 are then transmitted to block 6.

### 5—Calculation of the Desired Angles by Inverting the Reference Model (Block No. 6—FIG. 1)

The objective of this block is to invert the reference model considered (cf. example part 3 describing block No. 4 and its reference model) so as to retrieve the wheel angles that must be applied to the vehicle.

The lateral loadings calculated in part 4 describing block No. 5 as well as the vehicle speed obtained in block No. 2 and the transverse acceleration gammaT and the yaw rate form part of the inputs of this inverse model of block No. 6.

The inversion of the model of block No. 4 to obtain the angles to be applied to the steerable wheels is done as follows:
starting from equation G and already knowing all the other components of this equation, \dot{δ} is obtained;
then \dot{δ} is integrated to obtain 6;

δ₁₁, δ₁₂, δ₂₁, δ₂₂ are then obtained with equations H since all the other components of these equations are already known;
then δ₁₁, δ₁₂, δ₂₁, δ₂₂ and δ are replaced in the respective equations C, D, E, F with their values thereby making it possible to obtain the values of angular orientation αᵢⱼ to be given to each steerable wheel.

FIG. 2 describes a variant for calculating the steering orientation angle to be given to each wheel. It is differentiated by the fact that it uses additional inputs and a different way of calculating the four angles of the wheels.

In this variant the four lateral loadings F applied to the wheels are measured by sensors.

The wheel angles that must be applied to the vehicle are obtained with the aid of four slavings in terms of lateral loadings instead of the previously described inverting of the reference model. These slavings (block No. 6 of FIG. 2) can for example be carried out by “PID” (proportional integral derivative) or by an internal model.

1-10. (canceled)

11: A method of controlling steering orientation of a driven vehicle including at least two steerable wheels each of which is orientable independently of the other according to an inherent angle of orientation, the wheels belonging to an axle assembly of the vehicle, the method comprising:
collecting a lateral acceleration setpoint; and
calculating orientation setpoints for each steerable wheel as a function of the lateral acceleration setpoint,
wherein during the calculating the orientation setpoints of the steerable wheels, orientation setpoints are calculated for each of the wheels of the axle assembly so that the difference between the levels of grip of the wheels with respect to the ground is less than a limit value.

12: The method as claimed in claim 11, implemented on a vehicle including four steerable wheels each of which is orientable independently of the others according to an inherent angle of orientation, two of the wheels belonging to a front axle assembly of the vehicle and two others of the wheels belonging to a rear axle assembly of the vehicle, the method further comprising, during the calculating the orientation setpoints of the steerable wheels:
calculating orientation setpoints for each of the wheels of the front axle assembly so that the difference between the levels of grip of the wheels with respect to the ground is less than a first limit value; and
calculating orientation setpoints for each of the wheels of the rear axle assembly so that the difference between the levels of grip of the wheels with respect to the ground is less than a second limit value.

13: The method as claimed in claim 11, wherein the level of grip μ of a wheel is calculated by applying formula μ=Fy/F_{z}, with Fy representing the transverse force applied to the wheel by the ground and F_{z} representing the vertical force applied to the wheel by the ground.

14: The method as claimed in claim 13, wherein the vertical force F₂ applied to the wheel is estimated at least based on longitudinal and transverse acceleration of the vehicle, by taking into account static load of the vehicle and longitudinal and transverse dynamic load transfers.

15: The method as claimed in claim 14, wherein at least one of the longitudinal and transverse accelerations of the vehicle is constituted by or derived from a measurement signal delivered by at least one sensor.

16: The method as claimed in claim 14, wherein the longitudinal acceleration of the vehicle is obtained based on at least one measurement of instantaneous speed of the vehicle.

17: The method as claimed in claim 14, wherein the transverse acceleration of the vehicle is estimated based on a measurement of instantaneous speed of the vehicle and a measurement of an angle of rotation of the steering wheel of the vehicle.

18: The method as claimed in claim 12, wherein the level of grip μ₁ of a first wheel of the front axle assembly of the vehicle is calculated using function
$${μ}_{1} ≃ {F}_{y 11} / {F}_{z 11} = \frac{{M}_{front} ( γ t + {L}_{1} \ddot{ψ} )}{{F}_{z 11} + {F}_{z 12}}$$
in which F_{z11} represents the vertical force applied to this first wheel of the front axle assembly by the ground and F_{z12} represents the vertical force applied to the second wheel of the front axle assembly by the ground, M_{front} represents total vehicle mass distributed over the front axle assembly, γt represents the vehicle's lateral acceleration measured or evaluated at the center of gravity of the vehicle, L₁ represents the distance between the front axle assembly of the vehicle and the center of gravity, and ψ represents acceleration of yaw motion of the vehicle.

19: The method as claimed in claim 12, wherein the level of grip μ₂ of a first wheel of the rear axle assembly of the vehicle is calculated using function
$${μ}_{2} = {F}_{y 21} / {F}_{z 21} = \frac{{M}_{rear} ( γ t - {L}_{2} \ddot{ψ} )}{{F}_{z 21} + {F}_{z 22}}$$
in which F_{z21} represents vertical force applied to the first wheel of the rear axle assembly by the ground, F_{z12} represents vertical force applied to the second wheel of the rear axle assembly by the ground, Mᵣₑₐᵣ represents total vehicle mass distributed over the rear axle assembly, γt represents the vehicle's lateral acceleration measured or evaluated at the center of gravity of the vehicle, L₂ represents the distance between the rear axle assembly of the vehicle and the center of gravity, and ψ represents acceleration of yaw motion of the vehicle.

20: The method as claimed in claim 11, wherein each steerable wheel orientation setpoint is calculated by inverting a reference calculation model, the model comprising an operation calculating transverse force applied to the wheel as a function of orientation of the wheel and of parameters of dynamic behavior of the vehicle.
